(19) United States
(12) Patent Application Publication
(10) Pub. No.: US 2024/0125294 A1
(43) Pub. Date: Apr. 18, 2024

(54) FUEL INJECTION VALVE

(71) Applicant: Robert Bosch GmbH, Stuttgart (DE)

(72) Inventors: Andreas Luckert, Winnenden (DE); Andreas Glaser, Stuttgart (DE); Hikmet Yanmaz, Stuttgart (DE)

(21) Appl. No.: 18/452,041

(22) Filed: Aug. 18, 2023

(30) Foreign Application Priority Data
Oct. 14, 2022 (DE) 10 2022 210 875.2

(51) Int. Cl. F02M 61/20; F02M 51/06; F02M 61/10

(52) U.S. Cl. CPC F02M 61/205; F02M 51/0603; F02M 61/10

(57) ABSTRACT

A fuel injection valve for fuel injection systems of internal combustion engines, in particular for directly injecting fuel into the combustion chamber of an internal combustion engine. The fuel injection valve includes a solenoid, an armature acted upon in a closing direction by a return spring through the solenoid, and a valve needle connected to the armature in force-locking fashion for actuating a valve closing body, which together with a valve seat surface forms a sealing seat. An adjustment element for adjusting the spring force of a return spring is arranged in a connecting sleeve serving the inlet side fuel supply. The adjustment element is bounded outwardly by a thin-walled sleeve. The sleeve includes an axially aligned sleeve jacket and a radially extending sleeve base. The wall thickness of the sleeve base is reinforced relative to the wall thickness of the sleeve jacket of the sleeve.

### CROSS REFERENCE

The present application claims the benefit under 35 U.S.C. § 119 of German Patent Application No. DE 10 2022 210 875.2 filed on Oct. 14, 2022, which is expressly incorporated herein by reference in its entirety.

### FIELD

The present invention relates to a fuel injection valve.

### BACKGROUND INFORMATION

A fuel injection valve is described in German Patent No. DE 40 03 228 A1, in which a fuel filter is pressed into the fuel inlet nozzle at the inlet end of the fuel injection valve. This fuel filter is circumferentially provided with a brass ring, for example, which forms the pairing with the wall of the fuel inlet nozzle when the fuel filter is pressed in. The brass ring surrounds an annular, solid plastic section of the base body of the fuel filter, from which, for example, three bars extend in the longitudinal direction to a common bottom portion, from which the actual screen fabric is overmolded in these sub-areas. An adjustment sleeve downstream of the fuel filter is used to adjust the initial spring stress of a return spring abutting the adjustment sleeve.

Furthermore, in some conventional fuel injection valves, the adjustment sleeve and the fuel filter are present as a so-called combined component, i.e., the two functions of adjusting the initial spring stress of a return spring abutting the adjustment sleeve and filtering the incoming fuel are integrated in one component (see, for example, U.S. Pat. Nos. U.S. Pat. Nos. 5,335,863 A and 6,434,822 B1, and European Patent Application Nos. EP 1 296 057 B1, EP 2 426 351 A1 and EP 1 377 747 A1). All conventional solutions are characterized by the fact that a pressing area is provided in the area of the adjustment sleeve, which forms an interference fit with the wall of the connecting nozzle surrounding it, which is selected tightly so that the spring tension remains constant over the service life of the fuel injection valve, i.e., a slipping of the adjustment sleeve is ruled out.

### SUMMARY

A fuel injection valve including features of the present invention may have the advantage that an adjustment element is used as a combined component in the fuel inlet, which combines a high degree of functional integration (adjustment of the spring force of the return spring, filtering of the fuel), wherein the adjustment element is formed by a sleeve in the outward direction, which receives the filter element as an insert in its interior and encloses it securely and safely.

Advantageously, according to an example embodiment of the present invention, the thin-walled sleeve has an axially aligned sleeve jacket and a radially extending sleeve base, wherein the wall thickness of the sleeve base is reinforced compared to the wall thickness of the sleeve jacket of the sleeve. In this way, the sleeve base is given sufficient stability, and therefore the force required to establish a high-quality flanged connection between the filter element and the sleeve at the end of the adjustment element opposite the sleeve base does not lead to impermissible deformation or damage to the sleeve base. The perfect adjustability of the spring force of the return spring abutting the sleeve base is thus also ensured.

Advantageous further developments and improvements of the fuel injection valve disclosed herein are possible as a result of the measures disclosed herein.

According to an example embodiment of the present invention, in an ideal manner, the sleeve base of the sleeve has a wall thickness that is between a factor of 1.5 to 3 greater than the wall thickness of the remaining sleeve in its sleeve jacket. An exception to this may be the transition area between the sleeve base and the sleeve jacket, as this should not abruptly jump in its wall thickness in a step-like manner. Rather, an even, wedge-like transition over a short sleeve portion of the sleeve jacket should be selected.

### BRIEF DESCRIPTION OF THE DRAWINGS

Embodiment examples of the present invention are shown in simplified form in the figures and explained in more detail in the following description.

FIG. 1 shows an axial cut through a fuel injection valve according to the related art.

FIG. 2 shows an enlarged section from the fuel injection valve shown in FIG. 1 in area II in FIG. 1 with a configuration of the adjustment element according to the present invention.

FIG. 3 shows the adjustment element in a sectional view as a single component, according to an example embodiment of the present invention.

FIG. 4 is a symbolically shown flanging tool, according to an example embodiment of the present invention.

### DETAILED DESCRIPTION OF EXAMPLE EMBODIMENTS

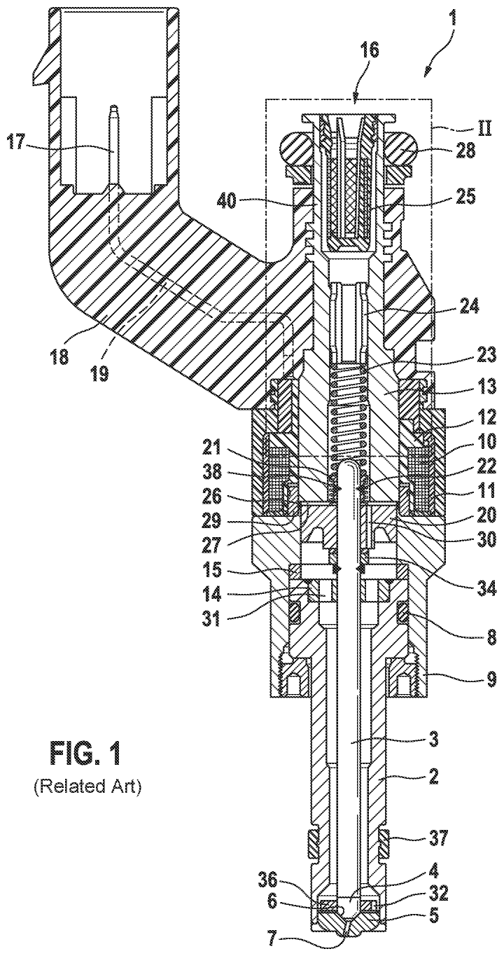

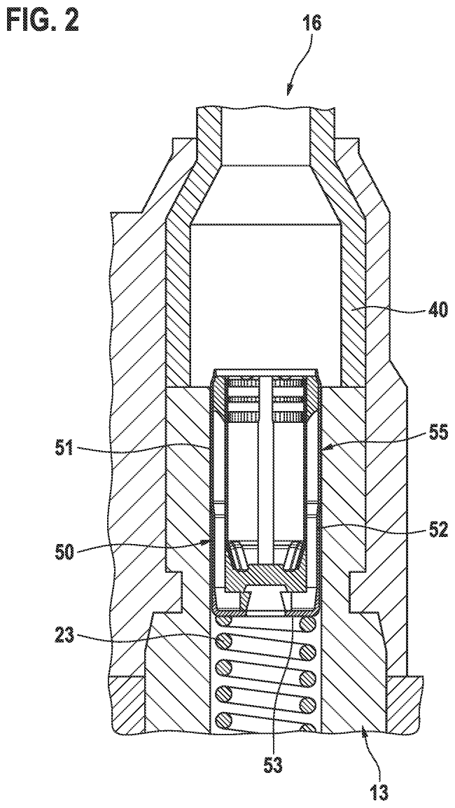

Before any exemplary embodiments of a fuel injection valve according to the present invention are described in more detail with the aid of FIGS. 2 to 4, a conventional (related art) fuel injection valve with respect to its essential components is to be briefly explained with the aid of FIG. 1 for a better understanding of the present invention.

The fuel injection valve 1 shown in FIG. 1 is designed in the form of a fuel injection valve 1 for fuel injection systems of mixture-compressing, externally ignited internal combustion engines. The fuel injection valve 1 is suitable, in particular, for the direct injection of fuel into a combustion chamber of an internal combustion engine, which is not shown.

The fuel injection valve 1 consists of a nozzle body 2 in which a valve needle 3 is arranged. The valve needle 3 is operatively connected to a valve closing body 4, which interacts with a valve seat surface 6 arranged on a valve seat body 5 to form a sealing seat. In the exemplary embodiment, the fuel injection valve 1 is an inwardly opening fuel injection valve 1, which has at least one spray opening 7. The nozzle body 2 is sealed by a seal 8 against an outer pole 9 of a solenoid 10. The solenoid 10 is encapsulated in a coil housing 11 and wound on a coil carrier 12, which abuts an inner pole 13 of the solenoid 10. The inner pole 13 and the outer pole 9 are separated from each other by a narrowing 26 and connected to each other by a non-ferromagnetic connection component 29. The solenoid 10 is energized via a line 19 from an electrical current that can be supplied via an electrical plug-in contact 17. The plug-in contact 17 is surrounded by a plastic shroud 18, which can be injected at the inner pole 13.

The valve needle 3 is guided in a valve needle guide 14, which is arranged in a disk-shaped manner. A paired adjustment disk 15 is used for the stroke adjustment. Upstream of the adjustment disk 15 is an armature 20. The latter is connected in force-locking fashion via a first flange 21 to the valve needle 3, which is connected to the first flange 21 by a weld joint 22. A return spring 23 is supported on the first flange 21, which in the present design of the fuel injection valve 1 is brought to an initial stress by an adjustment sleeve 24.

Fuel channels 30, 31, and 32 extend in the upper valve needle guide 14, in the armature 20, and on a lower guide element 36. The fuel is supplied via a central fuel supply 16 and filtered through a filter element 25. The fuel injection valve 1 is sealed by a seal 28 against a fuel distributor line not shown further and by a further seal 37 against a cylinder head not shown further. A pre-stroke spring 38 is arranged between the first flange 21 and the armature 20, which holds the armature 20 in abutment on the second flange 34 in the rest state of the fuel injection valve 1. The spring constant of the pre-stroke spring 38 is significantly smaller than the spring constant of the return spring 23.

In the rest state of the fuel injection valve 1, the armature 20 is loaded by the return spring 23 and the pre-stroke spring 38 opposite its stroke direction, such that the valve closing body 4 is held in sealing contact on the valve seat surface 6. When the solenoid 10 is energized, it builds up a magnetic field, which initially moves the armature 20 in the stroke direction against the spring force of the pre-stroke spring 38, wherein an armature clearance is predetermined by the distance between the first flange 21 and the armature 20. After passing through the armature clearance, the armature 20 also takes along the first flange 21, which is welded to the valve needle 3, in the stroke direction against the spring force of the return spring 23. The armature 20 passes through a total stroke corresponding to the height of the working gap 27 between the armature 20 and the inner pole 13. The valve closing body 4, which is in communication with the valve needle 3, lifts off from the valve seat surface 6, and the fuel guided through the fuel channels 30 to 32 is sprayed out through the spray opening 7.

When the coil current is switched off, the armature 20 drops from the inner pole 13 after sufficient reduction of the magnetic field by the pressure of the return spring 23, whereby the first flange 21 connected to the valve needle 3 moves opposite the stroke direction. This moves the valve needle 3 in the same direction, thereby placing the valve closing body 4 on the valve seat surface 6 and closing the fuel injection valve 1. The pre-stroke spring 38 then in turn acts upon the armature 20 such that it does not bounce back from the second flange 34 but returns to the rest state without a stop bouncer.

The inner pole 13 is sleeve-shaped towards the inlet end of the fuel injection valve 1 and in this respect forms a connection sleeve 40 in this area. The connecting sleeve 40 can also be formed as a separate component independent of the inner pole 13, in which the inner pole 13, for example, is then fitted. In the area of the connection sleeve 40, the filter element 25 is introduced, which serves to filter out such particles in the fuel that could otherwise lead to functional impairments on the relevant valve components, such as the sealing seat.

For example, the electromagnetic circuit may also be replaced by a piezoelectric actuator or a magnetostrictive actuator.

FIG. 2 shows an axial sectional view of the section designated in FIG. 1 with II as an exemplary embodiment of an adjustment element 50 according to the present invention, which is designed as a combined component and combines at least the functions of the adjustment sleeve 24 and the filter element 25.

In conventional approaches (e.g., German Patent Application No. DE 10 2016 226 135 A1), the adjustment element 50 can also consist of three individual parts. Here, a metallic sleeve 51 contains both a filter element 62 and a restrictor element 56. Such approaches indeed have a very high functional integration, but also disadvantageously are very difficult to assemble, which is associated with a high cost. The complicated assembly is inter alia also due to the very different design, different materials and methods of manufacture (e.g., deep-drawn part, rotating part, injection-molded part) of the individual components of the adjustment element 50.

In this respect, according to the present invention, a simplified solution is to be proposed compared to the aforementioned three-part solution of an adjustment element 50. Thus, the outer jacket of the adjustment element 50 forms a metal sleeve 51, which is designed, for example, having multiple steps and is produced by deep-drawing. The thin-walled sleeve 51 comprises, for example, a radially enlarged area in half of the sleeve on the inlet side, which represents the area of the adjustment element 50 with the largest diameter and which serves as the pressing area 55. The axially subsequent downstream section is a smaller diameter area of the adjustment element 50, which is only slightly smaller in outer diameter than the pressing area 55.

A filter element 62 is integrated in the deep-drawn sleeve 51 and comprises a plastic base body, in which a plastic or metal fabric is incorporated. The filter fabric is designed to be rigid such that the contour of the filter element 62 is invariably fixed. The filter element 62 has a larger diameter collar region 63 at its inlet end, which corresponds to the radially enlarged region of the sleeve 51 and is tightly fitted in this region in order to exclude disadvantageous gap formation in this region. The larger diameter collar region 63 of the filter element 62 has a circumferential chamfer 64 at its inlet on the outer circumference, which provides a tapering of the collar region 63. This chamfer 64 of the collar area 63 has a beveled shape to accurately form-fit the sleeve 51 to secure the filter element 62 in the thin-walled sleeve 51 thereto. The sleeve 51 is formed in this area, e.g., by means of flanging.

A possible restrictor element is placed outside of the adjustment element 50 in the fluid passage of the fuel injection valve 1. Particularly with high-pressure injector valves, which are supplied with a fuel pressure of >100 bar, for example, it has been shown that in operation there is considerable noise that can be perceived as partially disruptive. Effective noise reduction is accomplished by providing a restrictor element having a small opening cross-section (e.g., with a diameter of 0.4 mm to 1.5 mm) in the inlet area of the fuel injection valve 1. The restrictor bore may be used to selectively dampen pressure pulsations inside the fuel injection valve 1.

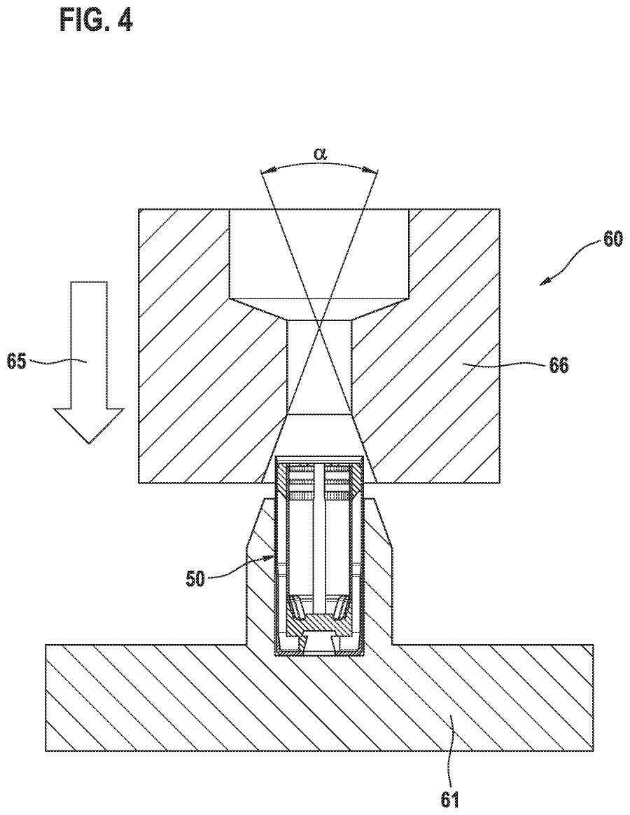

In order to be able to make the flanging connection between the sleeve 51 and the filter element 62 secure, slip-proof, and gap-free, a flanging tool 60 (see FIG. 4) must be used to apply correspondingly high flanging forces, which could lead to distortion problems of the sleeve 51 due to the thin wall of the deep-drawn sleeve 51. For this reason, a sleeve base 53 on the outlet side of the sleeve 51, on the inside of which, for example, the filter element 62 is seated, is advantageously reinforced relative to the jacket wall of the sleeve 51. In an ideal manner, the sleeve base 53 of the sleeve 51 has a wall thickness that is between a factor of 1.5 to 3 greater than the wall thickness of the remaining sleeve 51 in its sleeve jacket 52. In this way, the sleeve base 53 is given sufficient stability, and therefore the force required to establish a high-quality flanged connection of the sleeve 51 at the end of the adjustment element 50 opposite the sleeve base 53 does not lead to impermissible deformation or damage to the sleeve base 53. The perfect adjustability of the spring force of the return spring 23 abutting the sleeve base 53 is thus also ensured.

After assembly and welding of the connection sleeve 40 on the inner pole 13, the dynamic spray quantity and the spring force of the return spring 23 can finally be preset by moving the adjustment element 50.

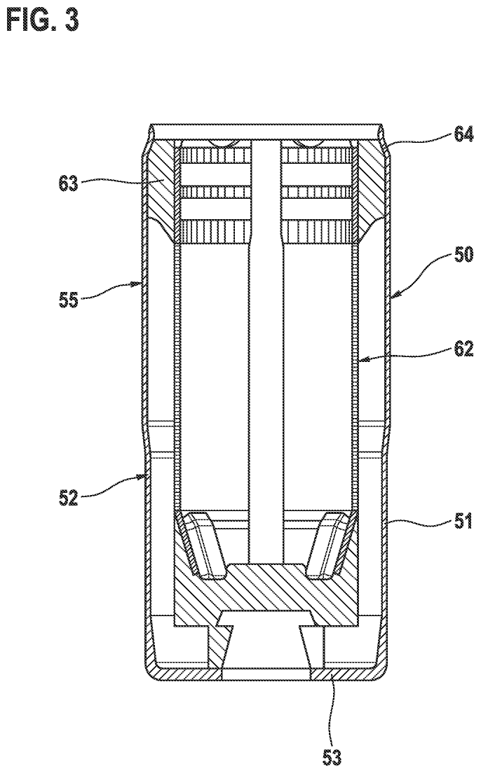

FIG. 3 shows the adjustment element 50 in a sectional view as a single component. This clearly shows the design of the sleeve 51, which, viewed over its axial length of the sleeve jacket 52, has a plurality of regions which have a different outer diameter, when viewed in the downstream direction, first the folded sleeve flanging area, then the area with the largest diameter, which serves as the pressing area 55, and finally the axially subsequent downstream section as an area with a slightly smaller diameter. This merges into the radially extending sleeve base 53, which has a reinforced wall thickness according to the present invention. In the bent transition from sleeve jacket 52 to sleeve base 53, the wall thickness after deep-drawing does not transition abruptly in step-like fashion to the other thickness, for example, but instead extends evenly with a wedge shape over a small length of the sleeve jacket 52, as can be seen in FIG. 3.

In FIG. 4, the flanging tool 60 required for the preparation of the flanged connection is symbolically shown. For example, the flanging tool 60 has a fixed workpiece holder 61 in which the adjustment element 50 to be flanged is held, and an axially movable punch 66, the direction of movement of which is indicated by arrow 65. The movable punch 66 has an inner hollow conical opening that is moved over the flanging area of the adjustment element 50 to initiate the flanging operation. The punch 66 as a hollow cone tool has an inside angle α of 30° to 60°, ideally of approximately 40°.

The present invention is not limited to the illustrated exemplary embodiments and can also be realized in a variety of other fuel injection valve designs compared to the fuel injection valve design shown in FIG. 1.

What is claimed is:

1. A fuel injection valve for a fuel injection system of an internal combustion engine, configured to inject fuel directly into a combustion chamber of the internal combustion engine, comprising:
an actuator, using which a lifting movement of a valve needle can be achieved, as a result of which an actuation of a valve closing body, which together with a valve seat surface forms a sealing seat, is enabled;
an inlet side fuel supply; and
an adjustment element configured to set a spring force of a return spring is arranged in the fuel inlet, the adjustment element is bounded outwardly by a sleeve, and the sleeve includes an axially aligned sleeve jacket and a radially extending sleeve base, wherein a wall thickness of the sleeve base is reinforced relative to a wall thickness of the sleeve jacket of the sleeve.

2. The fuel injection valve according to claim 1, wherein a sleeve base of the sleeve has a wall thickness that is between a factor 1.5 to 3 greater than the wall thickness of the remaining sleeve in the sleeve jacket.

3. The fuel injection valve according to claim 1, wherein the sleeve is a thin-walled deep-drawn component.

4. The fuel injection valve according to claim 1, wherein a filter element is inserted in the sleeve of the adjustment element.

5. The fuel injection valve according to claim 4, wherein the filter element has a collar region at an inlet end of the filter element, which corresponds to the sleeve, and is tightly fitted in a region of the collar region.

6. The fuel injection valve according to claim 5, wherein the collar region of the filter element includes a circumferential chamfer at the inlet of the filter element on an outer circumference.

7. The fuel injection valve according to claim 6, wherein the chamfer of the collar region of the filter element has a beveled shape such that the sleeve can be placed against it with accurate form-fit to secure the filter element in the thin-walled sleeve.

8. The fuel injection valve according to claim 4, wherein the filter element is attached and secured in the sleeve using flanging.

9. The fuel injection valve according to claim 1, wherein the sleeve, viewed over its axial length of the sleeve jacket, has a plurality of regions which have a different outer diameter, when viewed in a downstream direction, first a folded sleeve flanging area, then an area with a largest diameter, which serves as a pressing area, and finally an axially subsequent downstream section as an area with a slightly smaller diameter.
